(19) United States
(12) Patent Application Publication
(10) Pub. No.: US 2011/0255368 A1
(43) Pub. Date: Oct. 20, 2011

(54) Method for 2D and 3D electromagnetic field measurements using a towed marine electromagnetic survey system

(76) Inventors: Gustav G?ran Mattias S?dow, Vallingby (SE); Ulf Peter Lindqvist, Segeltorp (SE); Andras Robert Juhasz, Hagersten (SE)

(21) Appl. No.: 12/798,935

(22) Filed: Apr. 14, 2010

(51) Int. Cl. G01V 1/38

(52) U.S. Cl. 367/20

(57) ABSTRACT

A method for acquiring electromagnetic data in at least two dimensions includes towing a first streamer cable behind a vessel in a body of water, the first streamer cable including a reference line extending substantially along the entire length thereof, a plurality of spaced apart measuring electrodes electrically insulated from the reference line and a voltage measuring circuit functionally coupled between each measuring electrode and the reference line. At least a second streamer cable is towed at corresponding distance from the vessel. The second streamer cable is configured substantially as the first streamer cable. The second streamer cable is displaced from the first streamer cable in one of a horizontal plane and a vertical plane. At selected times an electromagnetic field is imparted into the water. Voltage difference is determined between each measuring electrode and the reference line, and a difference between voltages measured at least one electrode on each of the first and second streamer cables is determined.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine electromagnetic surveying. More specifically, the invention relates to a method and system for detecting electromagnetic signals in a marine environment in both in-line and cross-line directions.

2. Background Art

Marine controlled source electromagnetic (CSEM) surveying is a geophysical surveying technique that uses electromagnetic (EM) energy to identify possible hydrocarbon bearing rock formations below the bottom of a body of water such as a lake or the ocean. In a typical marine CSEM survey, an EM source and a number of EM receivers are located at or near the bottom of a body of water. The EM source is typically towed over an area of interest in the Earth's subsurface, and the receivers are disposed on the water bottom over the area of interest to obtain signals related to the distribution of electrical resistivity in the subsurface area of interest. Such surveying is performed for a range of EM source and EM receiver positions. The EM source emits either or both a time varying electric field and a time varying magnetic field, which propagate outwardly into the overlying seawater and downwardly into the formations below the water bottom. The receivers most commonly used detect and record the induced electric field at or near the water bottom. The time varying EM field may be induced by passing electric current through an antenna. The electric current may be continuous wave and have one or more discrete frequencies. Such current passing through an antenna is used for what is referred to as “frequency domain CSEM” surveying. It is also known in the art to apply direct current to an antenna, and produce transient EM fields by switching the current. Such switching may include, for example, switching on, switching off, inverting polarity and inverting polarity after a switch on or switch off event. Such switching may be equally time spaced or may be in a time series known as a “pseudo random binary sequence.” Such switched current is used to conduct what is referred to as a “transient CSEM” survey. One type of such survey is a multi-transient electromagnetic survey.

The EM energy is rapidly attenuated in the conductive seawater, but in less conductive subsurface formations is attenuated less and propagates more efficiently. If the frequency of the EM energy is low enough, the EM energy can propagate deep into the subsurface formations. Energy “leaks” from resistive subsurface layers, e.g., a hydrocarbon-filled reservoir, back to the water bottom. When the source-receiver spacing (“offset”) is comparable to or greater than the depth of burial of the resistive layer (the depth below the water bottom) the energy reflected from the resistive layer will dominate over the transmitted energy. CSEM surveying uses the large resistivity contrast between highly resistive hydrocarbons and conductive aqueous saline fluids disposed in permeable subsurface formations to assist in identifying hydrocarbon reservoirs in the subsurface.

U.S. Patent Application Publication No. 2009/0140741 discloses a system for acquiring EM data in three dimensions, that is, both in a direction along the direction of travel of a marine electromagnetic survey vessel, and a direction transverse to the direction of the survey vessel both in the vertical plane and in the horizontal plane.

In order to make the cross-line measurements described in the '741 publication, it is necessary to extend electrical conductors from the position of the electrodes used to make the cross-line measurements (typically corresponding electrodes on adjacent streamer cables) to the input of a voltage measuring circuit. The voltage measuring circuit may be on the survey vessel or at a convenient place, such as a lead in termination, at the forward end of one of the streamer cables. The long electrical conductors are subject to having voltages induced in them as a result of moving the streamer cables within the Earth's magnetic field. The amplitude of the induced voltage will depend on the velocity of the streamer cable, and the length of the electrical conductors from the respective electrodes to the voltage measuring circuit.

A method is known in the art for reducing the magnitude of the induced voltage in EM streamer cables. See, for example, U.S. Pat. No. 7,671,958 issued to Ronaess et al. The method and apparatus disclosed in the '958 patent is described with respect only to a single EM sensor streamer cable. There is no provision in the method and apparatus disclosed in the '958 patent for the very long electrical conductors needed to reduce induction noise in systems capable of measuring cross-line EM signals, such as disclosed in the '741 publication.

There is a need for improved methods and apparatus for correcting measurements made by 2D and 3D towed marine survey systems for induced voltage noise.

### SUMMARY OF THE INVENTION

A method according to one aspect of the invention for acquiring electromagnetic data in at least two dimensions includes towing a first streamer cable behind a vessel in a body of water, the first streamer cable including a reference line extending substantially along the entire length thereof, a plurality of spaced apart measuring electrodes electrically insulated from the reference line and a voltage measuring circuit functionally coupled between each measuring electrode and the reference line. At least a second streamer cable is towed at corresponding distance from the vessel. The second streamer cable is configured substantially as the first streamer cable. The second streamer cable is displaced from the first streamer cable in one of a horizontal plane and a vertical plane. At selected times an electromagnetic field is imparted into the water. Voltage difference is determined between each measuring electrode and the reference line, and a difference between voltages measured at least one electrode on each of the first and second streamer cables is determined.

Other aspects and advantages of the invention will be apparent from the following description and the appended claims.

### BRIEF DESCRIPTION OF THE DRAWINGS

FIG. 1 is a perspective view of an electromagnetic signal acquisition system that may be used in accordance with the present invention.

FIG. 2 shows more detail of one example of a sensor module in the cable system of FIG. 1.

FIG. 3 shows more detail of example measurement and communication circuitry of the sensor module shown in FIG. 2.

### DETAILED DESCRIPTION

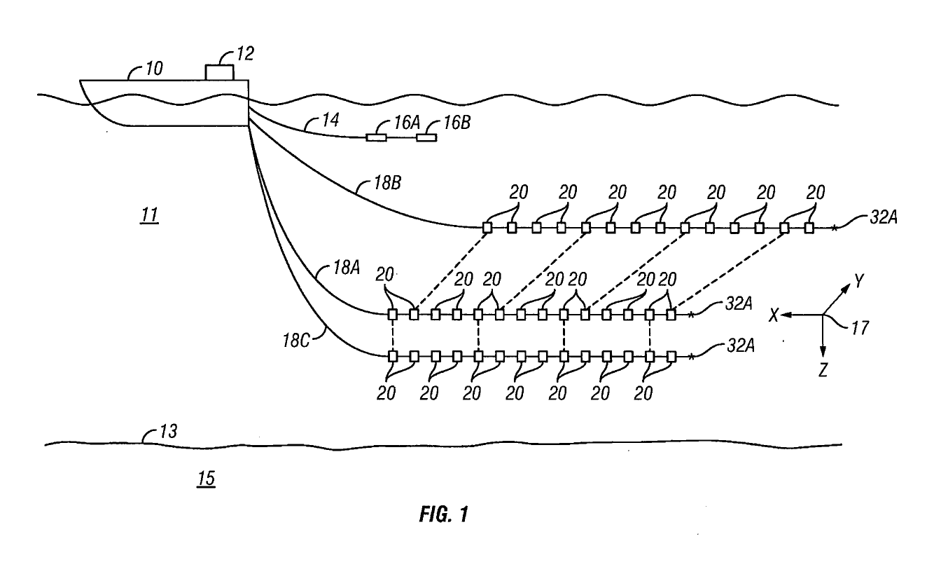

FIG. 1 is a perspective view of an electromagnetic signal acquisition system that may be used in accordance with the present invention. A survey vessel 10 moves along the surface of a body of water 11 such as a lake or the ocean. The survey vessel 10 may include thereon equipment shown at 12 and referred to for convenience as a “recording system.” The recording system 12 may include devices (none shown separately in FIG. 1) for navigation of the vessel, for imparting electric current to an electromagnetic transmitter (explained below) and for detecting and recoding signals generated by each of a plurality of electromagnetic receivers (explained below) on a plurality of streamer cables, which may be towed by the survey vessel 10 or by another vessel.

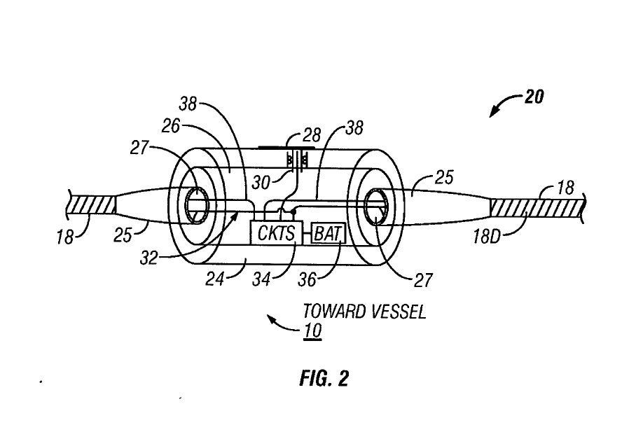

The transmitter in the present example may be an armored, insulated electrical cable 14 having thereon spaced apart electrodes 16A, 16B. At selected times, the recording system 12 will impart electric current across the electrodes 16A, 16B. The electrical current may be, for example, continuous wave low frequency (e.g., 0.01 to 1 Hz) alternating current at one or more discrete frequencies for frequency domain electromagnetic surveying, or some form of switched direct current (e.g. switched on, switched off, reversed polarity or a series of switching events such as a pseudo-random binary sequence) for time domain electromagnetic surveying. An electromagnetic field induced by the current flowing across the electrodes 16A, 16B travels through the water, into rock formations 15 below the water bottom 13 and is detected by electromagnetic receivers in receiver modules 20 disposed on first, second and third streamer cables 18A, 18B, 18C, respectively. Each streamer cable 18A, 18B, 18C may include an electrode 32A at the aft end thereof (furthest from the vessel 10). The electrode will be further explained with reference to FIG. 2.

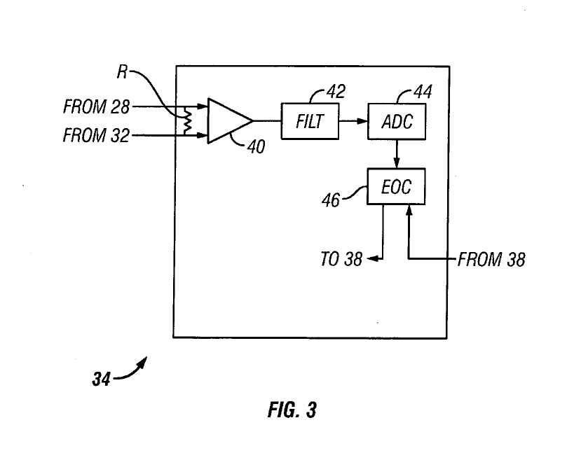

As will be explained further below with reference to FIGS. 2 and 3, each receiver module 20 may have circuitry proximate thereto for measuring voltage imparted between an electrode on the receiver module 20 and a reference potential line in response to the electromagnetic field imparted into the subsurface by the transmitter 14.

It should also be understood that while the present example transmitter, known as a horizontal electric dipole, uses a pair of electrodes spaced apart in the horizontal plane, other types of transmitters that may be used with the present invention include vertical electric dipoles (electrodes spaced apart in the vertical plane) or vertical or horizontal magnetic dipoles such as wire coils or loops having magnetic moment along the vertical and/or horizontal directions.

FIG. 1 also shows a coordinate system 17 used in the present description and to illustrate that the second streamer cable 18B may be displaced from the first streamer cable 18A in the horizontal plane or Y direction, and the third streamer cable 18C may be displaced from the first streamer cable 18A in the vertical plane or Z direction. The receiver modules 20 on all three streamer cables 18A, 18B, 18C may be positioned at corresponding longitudinal distances from the vessel 10 to simplify calculation of certain measurements. As will be explained further, the second and third streamer cables 18B, 18C may be used to obtain electric field measurements in the Y and Z directions, called the “cross-line” directions, by measuring voltages impressed across corresponding electrodes (i.e., longitudinally about the same distance from the survey vessel 10) on different streamer cables, as well as the so-called “in-line” direction across pairs of electrodes spaced apart in the X direction as explained above.

One example of a receiver streamer cable 18 (representative of any one of the receiver streamer cables 18A, 18B, 18C in FIG. 1) and one of the receiver modules 20 is shown in more detail in FIG. 2. The cable 18 may include on its exterior helically wound, electrically conductive armor wires 18D, such as may be made from stainless steel or other high strength, corrosion resistant, electrically conductive material. In one example, to be explained in more detail below, the streamer cable 18 may include one or more insulated electrical conductors and one or more optical fibers disposed inside the armor wires 18D. Using an externally armored cable as shown in FIG. 2 may have the advantages of high axial strength of and high resistance to abrasion.

The streamer cable 18 in the present example may be divided into segments, each of which terminates with a combination mechanical/electrical/optical connector 25 (“cable connector”) coupled to the longitudinal ends of each cable segment. The cable connector 25 may be any type known in the art to make electrical and/or optical connection, and to transfer axial loading to a mating connector 27. In the present example such mating connector 27 can be mounted in each longitudinal end of one of the receiver modules 20. The connectors 25, 27 resist entry of fluid under pressure when the connectors 25, 27 are coupled to each other.

The receiver module housing 24 is preferably pressure resistant and defines a sealed interior chamber 26 therein. The housing 24 may be made from electrically non-conductive, high strength material such as glass fiber reinforced plastic, and should have a wall thickness selected to resist crushing at the maximum hydrostatic pressure expected to be exerted on the housing 24. The mating connectors 27 may be arranged in the longitudinal ends of the housing 24 as shown in FIG. 2 such that axial loading along the cable 18 is transferred through the housing 24 by the coupled cable connectors 25 and mating connectors 27. Thus, the streamer cable 18 may be assembled from a plurality of connector-terminated segments each coupled to a corresponding mating connector on a receiver module housing 24. Alternatively, the cable 18 may include armor wires 18D extending substantially continuously from end to end, and the receiver modules 20 may be affixed to the exterior of the armor wires 18D.

An electromagnetic receiver, which may be a measuring electrode 28, is disposed on the outer surface of the housing 24, and may be made, for example, from lead, gold, graphite or other corrosion resistant, electrically conductive, low electrode potential material. Electrical connection between the measuring electrode 28 and measuring circuits 34 (explained in more detail with reference to FIG. 3) disposed inside the chamber 26 in the housing 24 may be made through a pressure sealed, electrical feed through bulkhead 30 disposed through the wall of the housing 24 and exposed at one end to the interior of the chamber 26. One such feed through bulkhead is sold under model designation BMS by Kemlon Products, 1424 N. Main Street, Pearland, Tex. 77581.

The measuring circuits 34 may be powered by a battery 36 disposed inside the chamber 26 in the housing 24. Battery power may be preferable to supplying power from the recording system (12 in FIG. 1) over insulated electrical conductors in the streamer cable 18 so as to reduce the possibility of any electromagnetic fields resulting from current flowing along the cable 18 from interfering with the electromagnetic survey measurements made in the various receiver modules 20.

The streamer cable 18 may include one or more optical fibers 38 for conducting command signals, such as from the recording system (12 in FIG. 1) to the circuits 34 in the various receiver modules 20, and for conducting signal telemetry from the receiver modules 20 to the recording system (12 in FIG. 1) or to a separate data storage device (not shown). An insulated electrical conductor 32 forming part of the cable 18 may pass through the chamber 26 in the housing 24 such that electrical continuity in such conductor 32 is maintained along substantially the entire length of the cable 18.

Optical telemetry may be preferable to electrical telemetry for the same reason as using batteries for powering the circuits 34, namely, to reduce the incidence of electromagnetic fields caused by electrical current moving along the cable 18. The insulated electrical conductor 32 in the present example serves as a common potential reference line between all of the receiver modules 20.

The insulated conductor 32 may be electrically in contact with the water (11 in FIG. 1) by using an electrode (32A in FIG. 1) at the aft end of the streamer cable 18. If the distance between the aft end of the streamer cable 18 and the transmitter (14 in FIG. 1) is sufficiently large, the voltage at the electrode (32A in FIG. 1) and thus along the entire electrical conductor 32 is substantially zero notwithstanding the electromagnetic field induced by the transmitter. In a method according to the invention, the same cable configuration as explained herein with reference to FIG. 2 and further explained with reference to FIG. 3 may be used for all three streamer cables (18A, 18B, 18C in FIG. 1), and in each case the conductor 32 will represent a substantially zero voltage reference line along the entire length of each streamer cable.

One example of the circuits 34 is shown in more detail in FIG. 3. The circuits 34 may include a resistor R electrically coupled between the measuring electrode (28 in FIG. 2) and the insulated conductor 32, which as explained above serves as a common reference. The resistor R is also electrically connected across the input terminals of a preamplifier 40. Thus, voltage drop across the resistor R resulting from voltage difference between a fixed potential reference (conductor 32) and the measuring electrode (28 in FIG. 2) will be input to the preamplifier 40. Such voltage drop will be related to magnitude of the electric field gradient existing where the measuring electrode (28 in FIG. 2) is located at any point in time.

Output of the preamplifier 40 may be passed through an analog filter 42 before being digitized in an analog to digital converter (ADC) 44. Alternatively, the preamplifier 40 output may be directly digitized and the output of the ADC 44 can be digitally filtered. Output of the ADC 44, whether digitally filtered or not, may be conducted to an electrical to optical signal converter (EOC) 46. Output of the EOC 46 may be applied to the one or more optical fibers (38 in FIG. 2) in the cable (18 in FIG. 2) such that optical signals representative of the voltage measured by each measuring electrode (28 in FIG. 2) with respect to the reference conductor (32 in FIG. 2) may be communicated to the recording system (12 in FIG. 1) or to a data storage unit. The type of optical or other signal telemetry used in any implementation is a matter of discretion for the system designer and is not intended to limit the scope of the invention.

Referring back to FIG. 1, voltage difference measurements between receiver modules 20 may be made in the in-line (X) direction, horizontal cross-line direction (Y), and vertical cross-line (Z) direction. In-line measurement is made by subtracting the voltage measurements made at a selected one of the receiver modules 20 on any streamer cable 18A, 18B, 18C from another receiver module 20 on the same streamer cable. Such subtraction can be performed by the recording system 12 because in the present example, optical signals representing the voltage between the measuring electrode (28 in FIG. 2) on each receiver module 20 and the common reference potential are transmitted to the recording system 12. Cross-line voltage difference measurements may be made in the horizontal plane (Y direction) by subtracting the voltage measured at a selected receiver module 20 on the first streamer cable 18A from the voltage measured at a corresponding receiver module 20 (corresponding meaning approximately the same longitudinal distance from the vessel 10) on the second streamer cable 18B. Cross-line voltage difference measurements may be made in the vertical plane similarly, only using the measurements from corresponding receiver module(s) 20 on the third streamer cable 18C.

Using a method according to the invention it is possible to make cross-line electric field measurements without the need to extend voltage measurement lines along entire streamer cables and between streamer cables, thus eliminating a possible source of induced voltage caused by moving the streamer cables in the Earth's magnetic field.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for acquiring electromagnetic data in at least two dimensions, comprising:
towing a first streamer cable behind a vessel in a body of water, the first streamer cable comprising:
a reference line extending substantially along the entire length of the cable;
a plurality of spaced apart measuring electrodes disposed along the cable and electrically insulated from the reference line; and
a plurality of voltage measuring circuits functionally coupled between each measuring electrode and the reference line;
towing at least a second streamer cable behind the vessel at corresponding distance from the vessel as the first streamer cable, the second streamer cable configured substantially as the first streamer cable, the second streamer cable displaced from the first streamer cable in one of a horizontal plane and a vertical plane;
at selected times, imparting an electromagnetic field in the body of water;
measuring voltage difference at each measuring electrode with respect to the reference line; and
determining a difference between voltages measured at least one electrode on each of the first and second streamer cables.

2. The method of claim 1 further comprising:
towing a third streamer cable at corresponding distance from the vessel as the first streamer cable, the third streamer cable configured substantially as the first streamer cable, the third streamer cable displaced from the first streamer cable in the other of the horizontal plane and the vertical plane with respect to the second streamer cable;
measuring voltage difference at each measuring electrode with respect to the reference line on the third streamer cable; and
determining a difference between voltages measured at least one pair of corresponding electrodes on the first and third streamer cables.

3. The method of claim 1 wherein voltage differences measured between each electrode and the reference line are converted to optical signals before communication to a recording unit on the vessel.

4. The method of claim 1 wherein the measuring voltage difference at each electrode is performed using a preamplifier proximate each electrode, an analog to digital converter coupled to an output of the preamplifier, and an electrical to optical signal converter coupled to an output of the analog to digital converter.

5. The method of claim 1 wherein each reference line terminates in an electrode in electrical contact with the body of water.
